(19) United States
(12) Patent Application Publication
(10) Pub. No.: US 2022/0053245 A1
(43) Pub. Date: Feb. 17, 2022

(54) SYSTEMS AND METHODS FOR AUGMENTING VIDEO CONTENT

(71) Applicants: ORI GUEZ, EVEN YEHUDA (IL); RONY KOWALSKI, MODIIN (IL)

(72) Inventors: ORI GUEZ, EVEN YEHUDA (IL); RONY KOWALSKI, MODIIN (IL)

(21) Appl. No.: 17/062,737

(22) Filed: Oct. 5, 2020

Related U.S. Application Data
(60) Provisional application No. 62/910,120, filed on Oct. 3, 2019.

(51) Int. Cl. H04N 21/81; H04N 21/462; H04N 21/41

(52) U.S. Cl. CPC H04N 21/8133; H04N 21/4126; H04N 21/4622

(57) ABSTRACT

A system and method for augmenting a broadcast video or produced video feed, the system including: a visual analysis engine adapted for labelling features of the broadcast video or produced video feed, wherein the labelling of features is performed using machine vision; a video overlay generator adapted for generating an overlay layer based on the labelled features for overlaying on the broadcast video, and an app running on a viewing device adapted for overlaying the overlay layer onto the broadcast video.

### CROSS-REFERENCE TO RELATED APPLICATIONS

This application claims priority to U.S. Provisional Application No. 62/910,120, filed on Oct. 3, 2019, which is hereby incorporated by reference.

### FIELD

Embodiments disclosed herein relate to systems and methods for augmenting video content.

### BACKGROUND

Sports fans playing videogame versions of their favorite sports have grown accustomed to receiving a wealth of on-screen data relating to the game and players and now desire an equivalent experience when watching televised sports. However, most sports events are broadcast in the same way as 20 years ago with text or graphic overlays being limited to those that can be added by TV production staff. Although smart TVs and media streamers have large installed bases worldwide, these have not used to improve the sports-watching experience.

Further, in some sports, such as ice hockey it can be very difficult to actually follow the game on screen due to the small size of the puck and the high speed of the game. Here again, videogame generated sports have an advantage as the position is known of all on-screen elements (pucks, balls, players) and these can be easily highlighted for enjoyable viewing.

One approach for tracking and highlighting plays in a sport is by attaching or embedding a transmitting device in the ball or puck. Receivers placed around the playing field use radio-location techniques to determine the position of the ball or puck and this is then highlighted on screen. Similarly, transmitting patches are attached to player clothing to track players and provide player information on screen. This information is then processed and transmitted to the studio for editing into the TV broadcast. The clear disadvantage of this approach is the need to install large numbers of transmitters and receivers in large numbers of venues attached to multiple pieces of sports equipment and players. Another approach employs multiple dedicated cameras in a venue with a server that collects the puck/ball information for subsequent processing. The clear disadvantage of this approach is the need to install large numbers of cameras with dedicated processing in large numbers of venues.

It would therefore be advantageous to be able to enhance sports viewing, providing more on-screen data and tracking options, but without the need for expensive retrofitting of sports venues and sports equipment.

### SUMMARY

Exemplary embodiments disclosed herein relate to a system and method for augmenting of video content in real time using machine vision techniques. In some embodiments, produced video is received by an augmented reality generation system (ARGS). Components of the ARGS, analyze the produced video to label features found in the video. The produced video is then augmented with text and/or graphic overlays based on the labelled features. In some embodiments, the overlay layers are separated from the broadcast video such that viewers of the augmented video can enable or disable different augmented overlay layers.

The use of ARGS enables augmentation without any change to existing broadcast video production processes. Further, there is no need for additional monitoring systems, cameras, embedded chips or receivers to be added to venues, sporting equipment or players.

In some embodiments, a system for augmenting video content includes: a visual analysis engine for labelling features of the video content; and a video overlay generator for augmenting video content with overlays based on the labelled features. In some embodiments, the overlays include inserting text and/or graphic overlays. In some embodiments, the text and/or graphic overlays include one or more of statistics, data, or game enhancers.

In some embodiments, game enhancers include at least one of ball/puck highlighting or ball/puck trails. In some embodiments, the video content includes a produced video feed. In some embodiments, the video content includes a sporting event. In some embodiments, the labelling of features is performed using machine vision. In some embodiments, data and/or statistics related to labelled features are retrieved from a database. In some embodiments, augmentations are selected from the list including: player names, player statistics, ball/puck speed, statistical heat maps, active player or players, virtual billboards, ball/puck trajectories, tactical analysis, and a combination of the above.

In some embodiments, the augmentation is transmitted separately as layers from the video content for decoding by a client/app. In some embodiments, the layers can be selectively activated or deactivated using the app/client. In some embodiments, the video content includes a broadcast video feed. In some embodiments, the system further includes a viewing device, wherein the augmentation is performed by the viewing device.

In some embodiments, a system for augmenting a broadcast video or produced video feed includes: a visual analysis engine adapted for labelling features of the broadcast video or produced video feed, wherein the labelling of features is performed using machine vision; a video overlay generator adapted for generating an overlay layer based on the labelled features for overlaying on the broadcast video, and an app running on a viewing device adapted for overlaying the overlay layer onto the broadcast video.

In some embodiments, the overlay layer is transmitted with the broadcast video. In some embodiments, the overlay layer is transmitted separately from the broadcast video. In some embodiments, the overlay layer includes text and/or graphic overlays. In some embodiments, the text and/or graphic overlays include one or more of statistics, data, or game enhancers. In some embodiments, game enhancers include at least one of ball/puck highlighting or ball/puck trails.

In some embodiments, the broadcast video or produced video feed includes a sporting event. In some embodiments, data and/or statistics related to labelled features are retrieved from a 3rd party statistics and information database. In some embodiments, the text and/or graphic overlays are selected from the group consisting of: player names, player statistics, ball/puck speed, statistical heat maps, active player, virtual billboards, and a combination of the above. In some embodiments, the overlay layer can be selectively activated or deactivated using the app. In some embodiments, the visual analysis engine and the video overlay generator are part of the viewing device.

In some embodiments, a non-transitory computer readable medium contains instructions that when executed by at least one processor, cause the at least one processor to perform a method for augmenting a broadcast video or produced video feed, the method including: labelling features of the broadcast video or produced video feed, wherein the labelling of features is performed using machine vision; generating an overlay layer based on the labelled features for overlaying on the broadcast video, and overlaying the overlay layer onto the broadcast video.

In some embodiments, the overlay layer is transmitted with the broadcast video. In some embodiments, the overlay layer is transmitted separately from the broadcast video. In some embodiments, the overlay layer includes one or more of statistics, data, or game enhancers. In some embodiments, game enhancers include at least one of ball/puck highlighting or ball/puck trails. In some embodiments, the method further includes retrieving the data and/or statistics related to labelled features from a 3rd party statistics and information database.

In some embodiments, the overlay layer includes text and/or graphic overlays selected from the group consisting of: player names, player statistics, ball/puck speed, statistical heat maps, active player, virtual billboards, and a combination of the above. In some embodiments, the method further includes activating or deactivating the overlay layer using the app. In some embodiments, the visual analysis engine and the video overlay generator are part of the viewing device.

As used herein, the term “ball” refers to any sporting object that is transferred between or manipulated by one or more players as part of a sport, such as but not limited to a puck, shuttlecock, Frisbee and so forth. As used herein, the term “player” refers to any participant in a sport as well as non-playing team members, officials, and so forth.

Unless otherwise defined, all technical and scientific terms used herein have the same meaning as commonly understood by one of ordinary skill in the art to which this invention belongs. The materials, methods, and examples provided herein are illustrative only and not intended to be limiting.

As used herein the terms “machine learning” or “artificial intelligence” refer to use of algorithms on a computing device that parse data, learn from this data, and then make a determination, where the determination is not deterministically replicable (such as with deterministically oriented software as known in the art). The term “machine vision” refers to identification of features in an image or video using machine learning techniques.

Implementation of the method and system of the present disclosure involves performing or completing certain selected tasks or steps manually, automatically, or a combination thereof. Moreover, according to actual instrumentation and equipment of preferred embodiments of the method and system of the present disclosure, several selected steps could be implemented by hardware or by software on any operating system of any firmware or a combination thereof. For example, as hardware, selected steps of the disclosure could be implemented as a chip or a circuit. As software, selected steps of the disclosure could be implemented as a plurality of software instructions being executed by a computer using any suitable operating system. In any case, selected steps of the method and system of the disclosure could be described as being performed by a data processor, such as a computing platform for executing a plurality of instructions.

Although the present disclosure is described with regard to a “computing device”, a “computer”, or “mobile device”, it should be noted that optionally any device featuring a data processor and the ability to execute one or more instructions may be described as a computing device, including but not limited to any type of personal computer (PC), a server, a distributed server, a virtual server, a cloud computing platform, a cellular telephone, an IP telephone, a smartphone, or a PDA (personal digital assistant). Any two or more of such devices in communication with each other may optionally form a “computer network”.

### BRIEF DESCRIPTION OF THE DRAWINGS

Aspects, embodiments and features disclosed herein will become apparent from the following detailed description when considered in conjunction with the accompanying drawings. Like elements may be numbered with like numerals in different FIGS.:

FIG. 1 illustrates schematically a system for augmenting video content according to some embodiments;

FIG. 2A shows a flowchart and 2B-2C show exemplary screenshots that illustrate schematically a system for augmenting video content according to some embodiments;

FIGS. 3A and 3B illustrate schematically a system for augmenting video content according to some embodiments;

FIG. 4A shows a flowchart and FIG. 4B shows an exemplary screenshot that illustrate schematically a system for augmenting video content according to some embodiments;

FIG. 5 illustrates schematically a system for augmenting video content according to some embodiments;

FIG. 6 shows a flowchart that illustrates a system for augmenting video content according to some embodiments;

FIGS. 7A and 7B that illustrate schematically a system for augmenting video content according to some embodiments;

FIG. 8 showing a flowchart for operation of a system for augmenting video content according to some embodiments.

### DETAILED DESCRIPTION

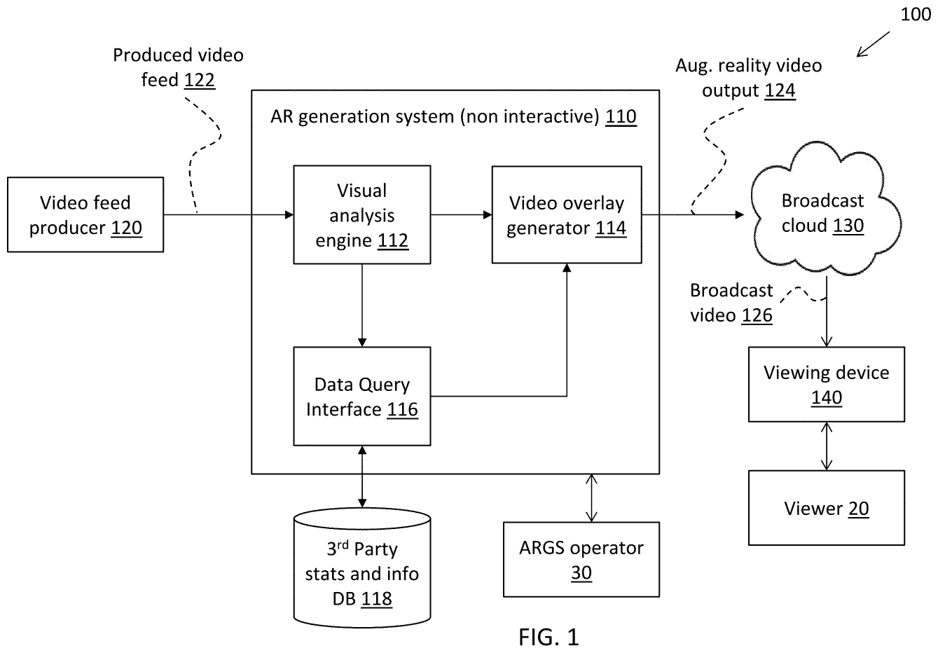

The present disclosure describes technological improvements in devices, systems, and methods for real-time augmenting of video content using machine vision techniques. Reference is now made to FIG. 1 that illustrates schematically a system for augmenting video content according to some embodiments. As shown in FIG. 1, a system 100 for non-interactive augmenting of video content includes an augmented reality generation system (ARGS) 110. ARGS 110 includes one or more computing devices. ARGS 110 and the modules and components that are included in ARGS 110 can run on a single computing device (e.g., a server) or multiple computing devices (e.g., multiple servers) that are configured to perform the functions and/or operations necessary to provide the functionality described herein. ARGS 110 includes software modules including: a visual analysis engine 112, a video overlay generator 114, and a data query interface 116.

The components of ARGS 110 interface to several external systems. Video feed production 120 creates video content. Non-limiting examples of video feed production 120 include TV studios, internet and over the air broadcasts from live events, and so forth. The output of video feed production 120 is a produced video feed 122.

ARGS 110 identifies items shown in video feed 122 (as will be described further below) and optionally makes use of third-party player and statistics databases 118. Although only one 3^{rd} party DB 118 is shown it should be appreciated that multiple 3^{rd} party DBs 118 may be consulted. The output of ARGS 110 is an augmented reality video output 124 including an augmented version of the input video feed 122. Video output 124 is distributed for broadcast or VOD playing by broadcast cloud 130 resulting in broadcast/streaming video 126. Broadcast cloud 130 includes broadcast entities such as cable or satellite TV providers and/or online streaming channel providers (Internet based). The broadcast video 126 is received by a viewing device 140 such as a TV, mobile phone, or tablet and viewed on viewing device 140 by a viewer 20.

ARGS 110 is configured and operated by an ARGS operator 30. ARGS operator 30 may be part of the same entity as video feed producer 120 that produces video feed 122. Alternatively ARGS operator 30 may be a 3^{rd} party providing an augmentation service on the content of video feed producer 120. In the embodiment of FIG. 1, viewer 20 has no control over the level or types of augmentation as these are determined by ARGS operator 30. The embodiment of FIG. 1 is thus for non-interactive augmented video.

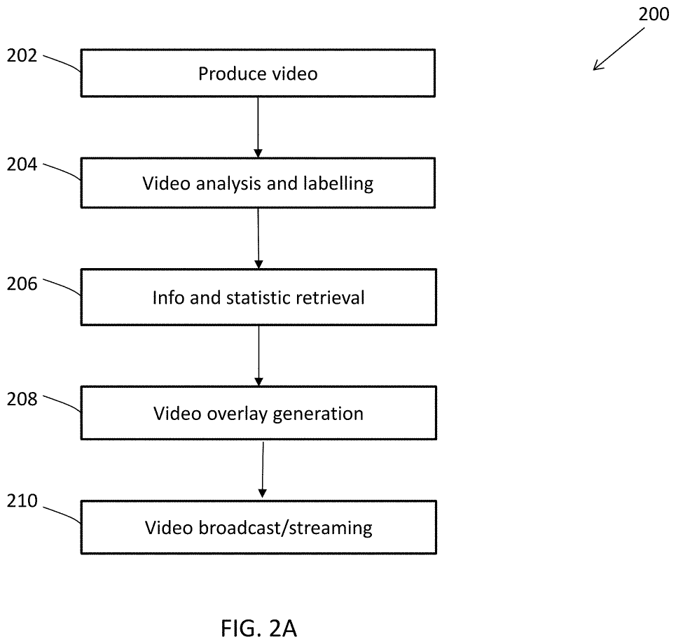

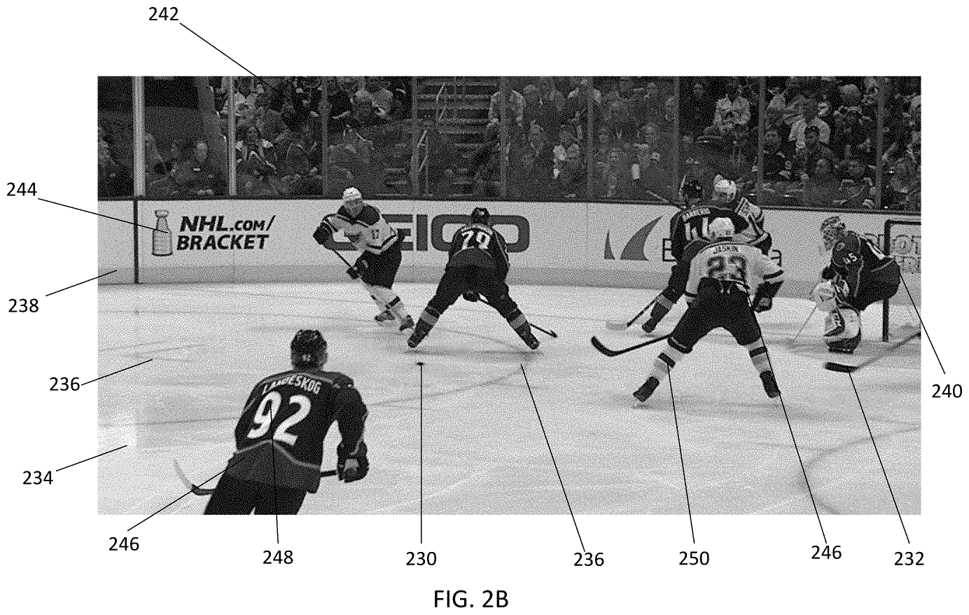

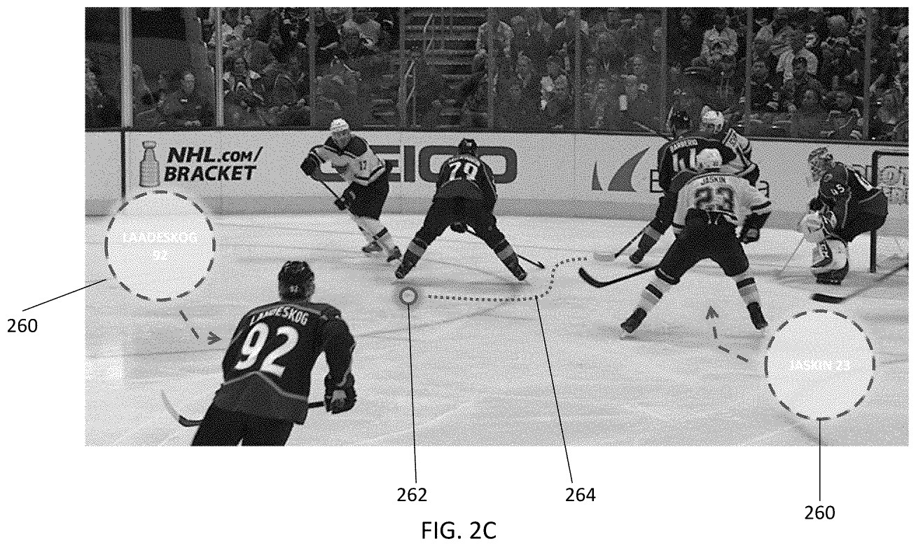

Reference is now made to FIG. 2A showing a flowchart and 2B-2C showing exemplary screenshots that illustrate schematically a system for augmenting video content according to some embodiments. FIG. 2A shows a process 200 for augmenting a video based on system 100 as described above. In step 202, video feed production 120 produces video feed 122. In the embodiments described herein, the content of the video feed 122 is a sporting event but it should be appreciated that any video content could be augmented using the systems described herein. As used herein a “produced video feed” 122 is video of an event that is ready for broadcast including production choices such as camera angles, addition of advertising, and so forth. FIG. 2B shows an illustrative screenshot from a produced video feed 122 of an ice hockey game.

In step 204, video feed 122 is received by visual analysis engine 112 for processing the frames and video of video feed 122 to identify and label items in video feed 122. The analysis of visual analysis engine 112 is based on machine vision techniques and is thus trained using machine learning algorithms to identify items related to the visual domain of interest. As presented herein, the domain of interest is sports and therefore the items that will be identified and labelled (as indicated on FIG. 2B) include but are not limited to:
sporting equipment including but not limited to balls, pucks 230, rackets, bats, sticks 232 etc.;
venue items including but not limited to courts, rinks 234, fields, markings 236, perimeters 238, goals 240, crowds 242, advertising 244, etc.;
player related items including but not limited to: players 246, player numbers 248, uniform colors 250, badges, officials etc.
on screen textual data including but not limited to: score, team data, timers, etc.

In step 206, the identified labels are fed into data query interface 116. Data query interface 116 then retrieves information from 3^{rd} party DB 118 related to the identified labels including but not limited to player names, player statistics, team statistics, game statistics, and so forth. In some embodiments, statistics and game info are stored locally in data query interface 116 and are thus retrieved locally without the need for 3^{rd} party DB 118. Data query interface 116 includes adaptation for interfacing to multiple 3^{rd} party DBs that may have different interfaces and DB protocols.

In step 208, video overlay generator 114 augments video feed 122 with textual and/or graphical statistics, data and game enhancers. An exemplary augmented screenshot is shown in FIG. 2C. As shown in FIG. 2C, augmentations can include: player names 260, game enhancers such as ball/puck highlighting 262 and ball/puck trails 264, and so forth. Game enhancers such as puck trails 264 are calculated over multiple frames by video-overlay generator 114 based on labelling received from video analysis engine 112. The exemplary screenshot of FIG. 2C displays some examples of augmentation and should not be considered limiting. Further augmentations are contemplated including but not limited to:
Player statistics (general and on-going game specific);
Strike zone (“box”) indicator in baseball during a pitch;
Ball/puck average and current speed;
Statistical “heat map” for penalty shots within a goal frame (such as in soccer/football) or serve ball hit area on a court (tennis), for a specific player or for portions of the game;
Active player or players controlling or in possession of the ball/puck;
Virtual billboards on static or dynamic surfaces.

The items to be labelled and augmented and text/graphics overlaid are chosen (from a predefined list) by ARGS operator 30, but ARGS operator 30 is not involved in the identification or overlay processes that are performed by components 112, 116 and 114. It should therefore be appreciated that the labelling and augmentation of steps 204 and 208 takes place in real time without the need for any modifications or additions to the game equipment, venue, or players.

In step 210, augmented video output 124 is fed to broadcast cloud 130 for broadcast or streaming to viewing devices 140 of viewers 20. In some embodiments, operators in broadcast cloud 130 offer viewers 20 the option to view a channel featuring the original video feed 122 and another separate channel featuring augmented video output 124.

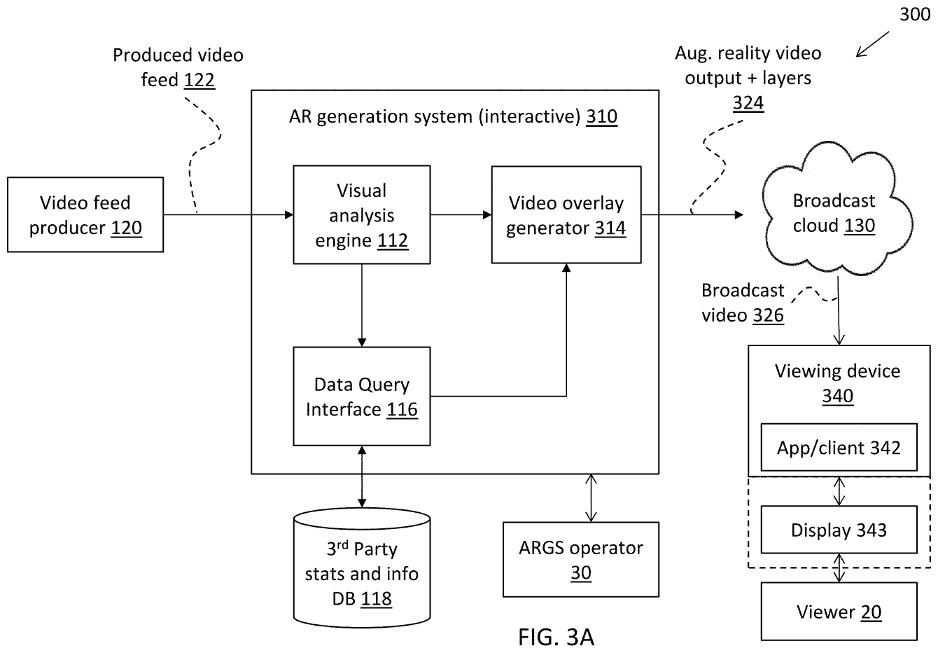

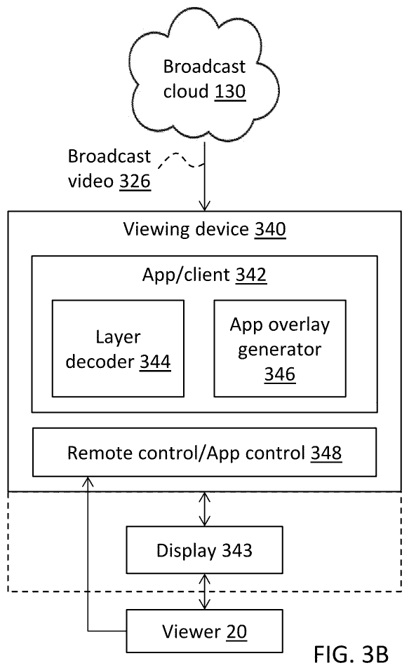

Reference is now made to FIGS. 3A and 3B that illustrate schematically a system for augmenting video content according to some embodiments. As shown in FIG. 3A, an interactive system 300 for augmenting video content includes an augmented reality generation system (ARGS) 310. ARGS 310 includes one or more computing devices. ARGS 310 includes software modules including: a visual analysis engine 112, a video overlay generator 314, and a data query interface 116.

The components of ARGS 310 and external interfaces are the same as ARGS 110 as described above with reference to FIG. 1 with the exception of video overlay generator 314 that generates a video output including augmented overlay layers that can be activated or deactivated by viewer 20.

The broadcast video 326 is received by a viewing device 340 such as a TV, mobile phone, or tablet running an augmented TV client or app 342. In some embodiments, viewing device 340 includes a display 343. In some embodiments, viewing device is a set top box, streamer decoder or similar device that does not include display 343 but rather has an interface to display 343. App 342 includes a layer decoder 344 and an app overlay generator 346. Viewer 20 interacts with app 342 to enable or disable the augmented layers to determine what is viewed by viewer 20.

ARGS 110 is configured and operated by an ARGS operator 30. ARGS operator 30 may be part of the same entity as video feed producer 120 that produces video feed 122. Alternatively ARGS operator 30 may be a 3^{rd} party providing an augmentation service on the content of video feed producer 120. In the embodiment of FIG. 3, viewer 20 has control over the layers of augmentation displayed, but the level or types of augmentation available for display are determined by ARGS operator 30.

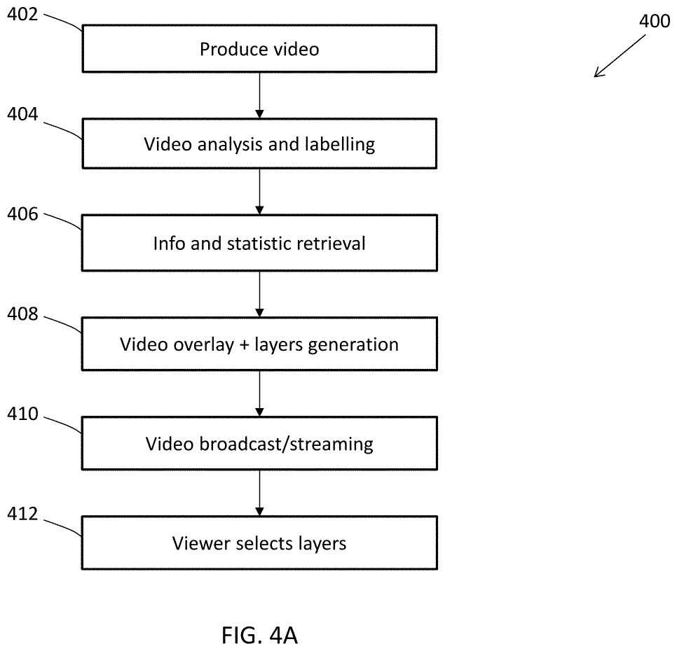

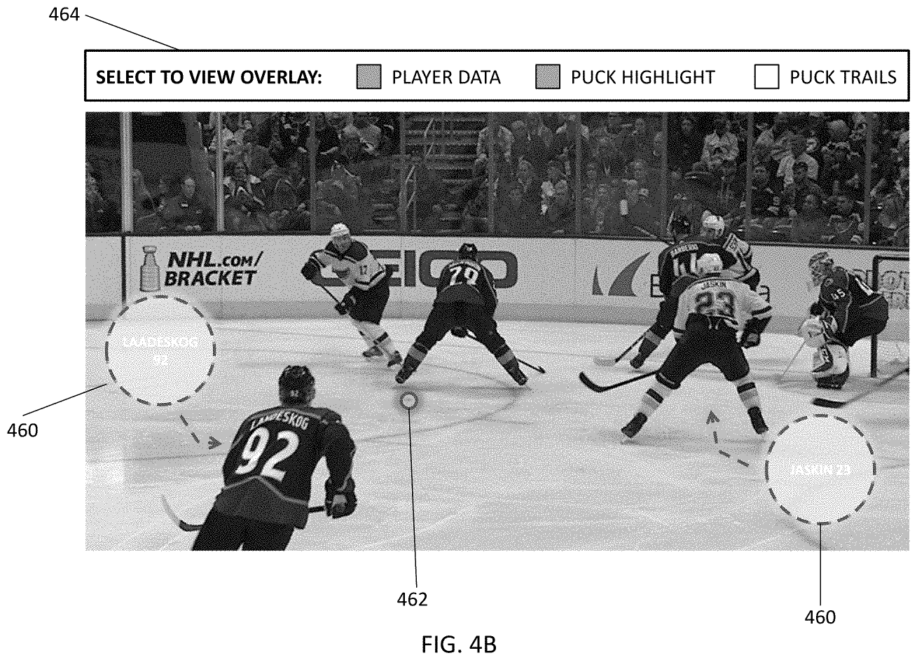

Reference is now made to FIG. 4A showing a flowchart and 4B showing an exemplary screenshot that illustrate schematically a system for augmenting video content according to some embodiments. FIG. 4A shows a process 400 for augmenting a video based on system 300 as described above. Steps 402 to 406 are the same as steps 202 to 206 as described above with reference to FIG. 2A.

In step 408, video overlay generator 314 augments video feed 122 with overlays including textual and/or graphical statistics, data and game enhancers. The overlays are provided in the form of layers that can be activated or deactivated by a viewer 20. The items to be labelled and augmented and text/graphics overlaid are chosen (from a predefined list) by ARGS operator 30, but ARGS operator 30 is not involved in the identification or overlay processes that are performed by components 112, 116 and 314. It should therefore be appreciated that the labelling and augmentation of steps 404 and 408 takes place in real time without the need for any modifications or additions to the game equipment, venue, or players.

In step 410, augmented video output with overlay layers 324 is fed to broadcast cloud 130 for broadcast or streaming to viewing devices 440 of viewers 20. The layers include metadata representing the augmentations that are streamed to the app/client 342 in the video output. In step 412 viewers watch the stream/broadcast using app 342 on viewing device 340 and choose layers of augmentation for activating or deactivating. Layer decoder 344 determines the layers available based on the metadata received and presents these to the viewer 20 for activating or deactivating. Interaction with the viewing devices described herein (such as device 340) may include viewing, or selecting graphical elements using the interface hardware of the viewing devices including but not limited to a remote control or app control 348 including a touchscreen, mouse, keyboard and so forth. When viewer 20 activates a layer (such as by using a remote control or app control 348), app overlay generator 346 adds the augmentation of that layer to the view seen by viewer 20. An exemplary augmented screenshot is shown in FIG. 4B. As shown in FIG. 4B, augmentations can include: player names 460, game enhancers such as ball/puck highlighting 462, and so forth. Augmentation selection menu 464 enables activating or deactivating layers of augmentation. The exemplary screenshot of FIG. 4B displays some examples of augmentation and should not be considered limiting.

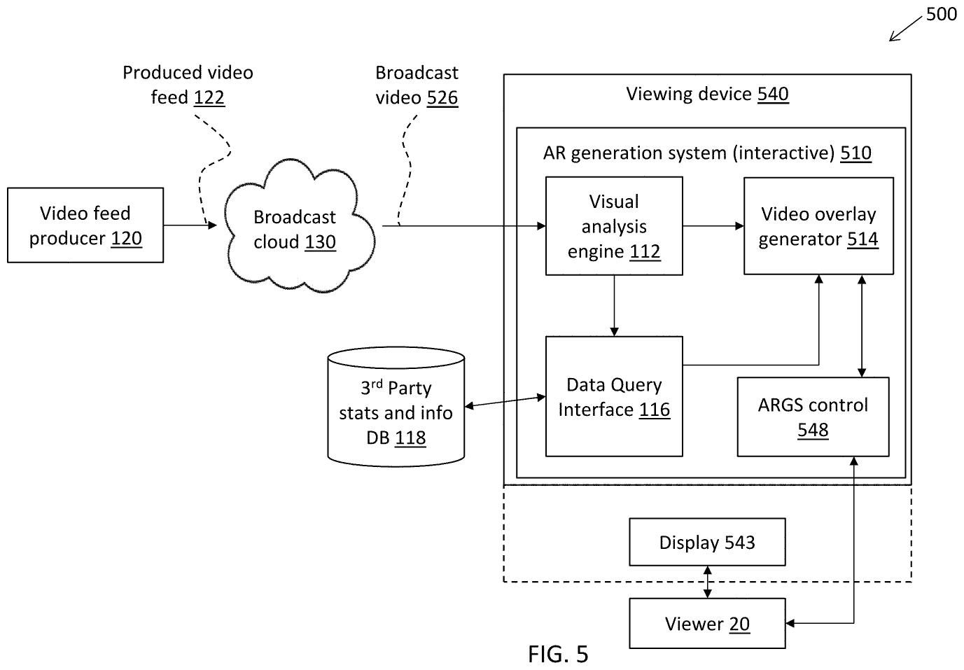

Reference is now made to FIG. 5 that illustrates schematically a system for augmenting video content according to some embodiments. As shown in FIG. 5, an interactive system 500 for augmenting video content includes a viewing device 540 with an embedded augmented reality generation system (ARGS) 510.

Non limiting examples of a viewing device 540 include a TV, mobile phone, or tablet. In some embodiments, viewing device 540 includes a display 543. In some embodiments, viewing device is a set top box, streamer, decoder or similar device that does not include display 543 but rather has an interface to display 543. Viewing device 540 includes a one or more computing devices for running ARGS 510 that includes software modules including: a visual analysis engine 112, a video overlay generator 514, and a data query interface 116.

The components of ARGS 510 and external interfaces are the same as ARGS 110 as described above with reference to FIG. 1 with the exception of video overlay generator 514 that generates a video output including augmented overlay layers that can be activated or deactivated by viewer 20. ARGS 510 also includes an ARGS control interface 548 for selection by viewer 20 of the augmented layers to be displayed.

In the embodiment of FIG. 5, a produced video feed 122 is provided by a video feed producer 120 to a broadcast cloud 130. Video feed 122 is broadcast or streamed as broadcast video 526 for receiving by viewer device 540. Viewer 20 interacts with ARGS 510 to enable or disable the augmented layers to determine what is viewed by viewer 20.

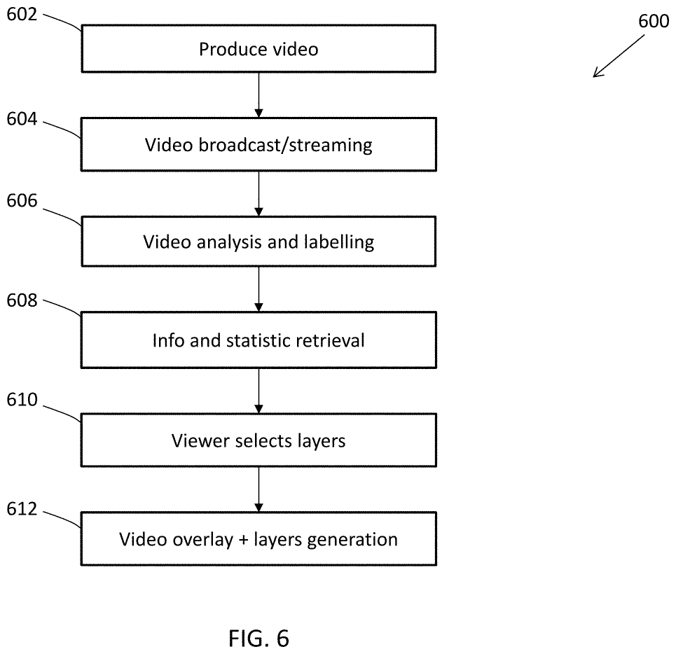

Reference is now made to FIG. 6 showing a flowchart that illustrates a system for augmenting video content according to some embodiments. FIG. 6 shows a process 600 for augmenting a video based on system 500 as described above. Step 602 is the same as step 202 as described above with reference to FIG. 2A. In step 604, produced video 122 is fed to broadcast cloud 130 for broadcast or streaming as broadcast video 526 to viewing devices 540 of viewers 20.

In step 606, broadcast video 526 is received by visual analysis engine 112 of ARGS 510 for processing the frames and video of broadcast video 526 to identify and label items in broadcast video 526. The analysis of visual analysis engine 112 is based on machine vision techniques and is thus trained using machine learning algorithms to identify items related to the visual domain of interest. Step 608 is the same as step 206 as described above with reference to FIG. 2A.

In step 610, viewers watch the stream/broadcast on viewing device 540 and choose overlays of augmentation for activating or deactivating via ARGS control 548 such as using the interface shown in FIG. 4B. In step 612 video overlay generator 514 augments broadcast video 526 with overlays (as selected by viewer 20) including textual and/or graphical statistics, data and game enhancers. It should be appreciated that the labelling and augmentation of process 600 takes place in real time without the need for any modifications or additions to the game equipment, venue, or players. It should further be appreciated that, in the embodiment of FIG. 5 and FIG. 6, no change is made in the production or broadcasting of the video feed—the addition of augmented content is made in viewing device 540 as desired by viewer 20.

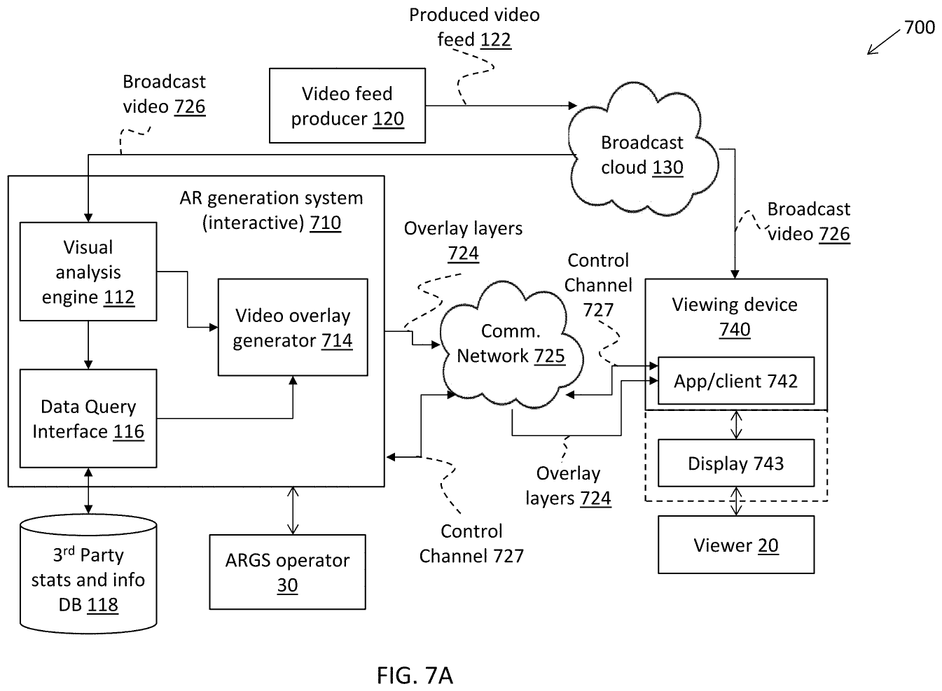

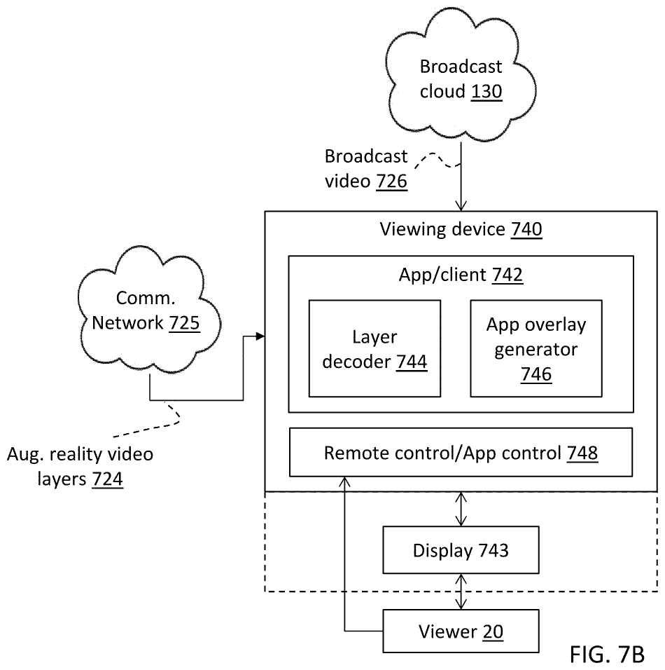

Reference is now made to FIGS. 7A and 7B that illustrate schematically a system for augmenting video content according to some embodiments. As shown in FIGS. 7A and 7B, an interactive system 700 for augmenting video content includes an augmented reality generation system (ARGS) 710. ARGS 710 includes one or more computing devices. ARGS 710 includes software modules including: a visual analysis engine 112, a video overlay generator 714, and a data query interface 116.

Produced video feed 122 is distributed for broadcast or VOD playing by broadcast cloud 130 resulting in broadcast/streaming video 726. Broadcast cloud 130 includes broadcast entities such as cable or satellite TV providers and/or online streaming channel providers (Internet based).

The components of ARGS 710 and external interfaces are the same as ARGS 110 as described above with reference to FIG. 1 with the exception of video overlay generator 714 that generates only overlay layers 724 that can be activated or deactivated by viewer 20 for addition to a broadcast video 726. Overlay layers 724 are transmuted via a communication network 725 such as the Internet to viewing devices 740.

The broadcast video 726 is received both by ARGS 710 and by a viewing device 740 such as a TV, mobile phone, or tablet running an augmented TV client or app 742. In some embodiments, viewing device 740 includes a display 743. In some embodiments, viewing device is a set top box, streamer decoder or similar device that does not include display 743 but rather has a hardware interface to a display 743. App 742 includes a layer decoder 744 and an app overlay generator 746. Viewer 20 interacts with app 742 to enable or disable the augmented layers to determine what is viewed by viewer 20.

ARGS 710 is configured and operated by an ARGS operator 30. In the embodiment of FIGS. 7A and 7B ARGS operator 30 may be a 3^{rd} party providing an augmentation service over the content of video feed producer 120. In the embodiment of FIGS. 7A and 7B, viewer 20 has control over the layers of augmentation displayed, but the level or types of augmentation available for display are determined by ARGS operator 30. In some embodiments, a control channel 727 provides two-way communication between app 742 and ARGS 710 that carries data other than the overlay layers 724. In some embodiments, control channel 727 is provided together with overlays 724. Non-limiting examples of the communications transmitted on control channel 727 include:
Initiating an ARGS video stream augmentation request by a viewer 20. This request will include video stream (122, 726) identification parameters;
Sending video stream application specific attributes to ARGS 710 (e.g. which sport is being viewed, real time or off-line operation, licensed or unlicensed content);
Video stream synchronization messages between ARGS 710 and app 742;
Viewer 20 subscription information.

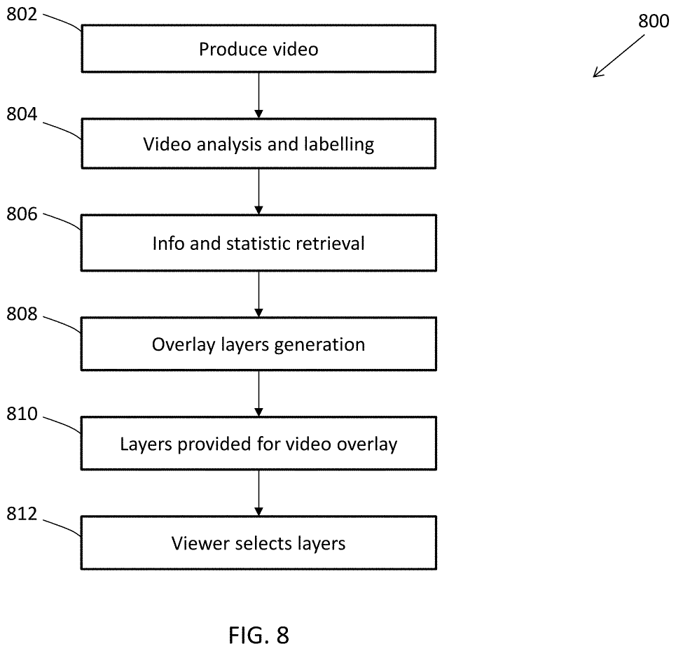

Reference is now made to FIG. 8 showing a flowchart for operation of a system for augmenting video content according to some embodiments. FIG. 8 shows a process 800 for augmenting a video based on system 700 as described above.

In step 802, video feed production 120 produces video feed 122. As used herein a “produced video feed” 122 is video of an event that is ready for broadcast including production choices such as camera angles, addition of advertising, and so forth. Produced video feed 122 is distributed for broadcast or VOD playing by broadcast cloud 130 resulting in broadcast/streaming video 726.

In step 804, broadcast video 726 is received by visual analysis engine 712 for processing the frames and video of broadcast video 726 to identify and label items in broadcast video 726. The analysis of visual analysis engine 712 is based on machine vision techniques and is thus trained using machine learning algorithms to identify items related to the visual domain of interest.

In step 806, the identified labels are fed into data query interface 116. Data query interface 116 then retrieves information from 3^{rd} party DB 118 related to the identified labels including but not limited to player names, player statistics, team statistics, game statistics, and so forth. In some embodiments, statistics and game info are stored locally in data query interface 116 and are thus retrieved locally without the need for 3^{rd} party DB 118.

In step 808, video overlay generator 714 generates augmented reality video overlay layers 724 that include textual and/or graphical statistics, data and game enhancers. The overlay layers 724 are layers that can be activated or deactivated by a viewer 20. The items to be labelled and augmented and text/graphics that form part of the overlays are chosen (from a predefined list) by ARGS operator 30. It should therefore be appreciated that the labelling and augmentation of steps 804 and 808 takes place in real time without the need for any modifications or additions to the game equipment, venue, or players. “Real time” as used in the embodiments herein implies providing the augmentation overlays concurrently with the broadcast or within a period of time not discernable to viewers of the broadcast such that the broadcast does not need to be delayed in order for the augmentation to be provided.

In step 810, augmented reality video overlay layers 724 are provided via communication network 725 to viewing devices 740 of viewers 20. Broadcast video 726 is also received by viewing device 740. In step 812 viewers watch the stream/broadcast using app 742 on viewing device 740 and choose layers of augmentation for activating or deactivating. Layer decoder 744 determines the augmentations available based on the augmented reality video overlay layers 724 received and presents these to the viewer 20 for activating or deactivating. When viewer 20 activates a layer (such as by using a remote control or app control 748), app overlay generator 746 adds the augmentation of that layer to the received broadcast video 726 such that the view seen by viewer 20 is a combination of the broadcast video 726 and the selected AR video overlay layers 724. An exemplary augmented screenshot is shown in FIG. 4B. As shown in FIG. 4B, augmentations can include: player names 460, game enhancers such as ball/puck highlighting 462, and so forth. Augmentation selection menu 464 enables activating or deactivating layers of augmentation. The exemplary screenshot of FIG. 4B displays some examples of augmentation and should not be considered limiting.

In the claims or specification of the present application, unless otherwise stated, adjectives such as “substantially” and “about” modifying a condition or relationship characteristic of a feature or features of an embodiment of the invention, are understood to mean that the condition or characteristic is defined to within tolerances that are acceptable for operation of the embodiment for an application for which it is intended.

It should be understood that where the claims or specification refer to “a” or “an” element, such reference is not to be construed as there being only one of that element.

In the description and claims of the present application, each of the verbs, “comprise” “include” and “have”, and conjugates thereof, are used to indicate that the object or objects of the verb are not necessarily a complete listing of components, elements or parts of the subject or subjects of the verb.

As used herein, the terms “machine-readable medium” “computer-readable medium” refers to any computing device, computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

While this disclosure describes a limited number of embodiments, it will be appreciated that many variations, modifications and other applications of such embodiments may be made. The disclosure is to be understood as not limited by the specific embodiments described herein, but only by the scope of the appended claims.

1. A system for augmenting a broadcast video or produced video feed comprising:
a) an augmented reality generation system running on a first device, the system including
a visual analysis engine adapted for labelling features of the broadcast video or produced video feed, wherein the labelling of features is performed using machine vision, and
a video overlay generator adapted for generating an overlay layer based on the labelled features, and
b) an app running on a viewing device adapted for overlaying the overlay layer onto the broadcast video.

2. The system of claim 1, wherein the overlay layer is transmitted from the augmented reality generation system with the broadcast video to the app.

3. The system of claim 1, wherein the overlay layer is transmitted from the augmented reality generation system to the app separately from the broadcast video.

4. The system of claim 1, wherein the overlay layer comprises text and/or graphic overlays.

5. The system of claim 4, wherein the text and/or graphic overlays comprise one or more of statistics, data, or game enhancers.

6. The system of claim 3, wherein game enhancers comprise at least one of ball/puck highlighting or ball/puck trails.

7. The system of claim 1, wherein the broadcast video or produced video feed comprises a sporting event.

8. The system of claim 5, wherein data and/or statistics related to labelled features are retrieved from a 3^{rd} party statistics and information database.

9. The system of claim 4, wherein the text and/or graphic overlays are selected from the group consisting of: player names, player statistics, ball/puck speed, statistical heat maps, active player, virtual billboards, and a combination of the above.

10. The system of claim 10, wherein the overlay layer can be selectively activated or deactivated using the app.

11. (canceled)

12. A non-transitory computer readable medium containing instructions that when executed by at least one processor, cause the at least one processor to perform a method for augmenting a broadcast video or produced video feed, the method comprising:
a) by an augmented reality generation system, labelling features of the broadcast video or produced video feed, wherein the labelling of features is performed using machine vision and generating an overlay layer based on the labelled features for overlaying on the broadcast video, and
b) by an app running on a viewing device, overlaying the overlay layer onto the broadcast video.

13. The method of claim 12, wherein the overlay layer is transmitted from the augmented reality generation system with the broadcast video to the app.

14. The method of claim 12, wherein the overlay layer is transmitted from the augmented reality generation system to the app separately from the broadcast video.

15. The method of claim 12, wherein the overlay layer comprises one or more of statistics, data, or game enhancers.

16. The method of claim 15, wherein game enhancers comprise at least one of ball/puck highlighting or ball/puck trails.

17. The method of claim 15, further comprising retrieving the data and/or statistics related to labelled features from a 3rd party statistics and information database.

18. The method of claim 15, wherein the overlay layer comprises text and/or graphic overlays selected from the group consisting of: player names, player statistics, ball/puck speed, statistical heat maps, active player, virtual billboards, and a combination of the above.

19. The method of claim 12, further comprising activating or deactivating the overlay layer using the app.

20. (canceled)

21. A system for augmenting a broadcast video or produced video feed comprising:
a) an augmented reality generation system running on a first device, the system including
a visual analysis engine adapted for labelling features of the broadcast video or produced video feed, wherein the labelling of features is performed using machine vision, and
a video overlay generator adapted for generating a plurality of augmented layers wherein each of the plurality of augmented layers is based on one or more of the labelled features, and
b) an app running on a viewing device configured for simultaneously activating two or more of the plurality of augmented layers and for overlaying the activated augmented layers onto the broadcast video.
